(19) United States
(12) Patent Application Publication
(10) Pub. No.: US 2024/0419654 A1
(43) Pub. Date: Dec. 19, 2024

(54) SEGMENTED DATABASE AUDITING SYSTEM

(71) Applicant: T-Mobile USA, Inc., Bellevue, WA (US)

(72) Inventors: Anuj Sharma, Broadlands, VA (US); Anil Kumar Mariyani, Ashburn, VA (US); Deepesh Belwal, Ashburn, VA (US); Sriharsha Kadalbal, Sammamish, WA (US)

(21) Appl. No.: 18/337,291

(22) Filed: Jun. 19, 2023

(51) Int. Cl. G06F 16/23; G06F 16/22; G06F 16/25

(52) U.S. Cl. CPC G06F 16/2365; G06F 16/22; G06F 16/25

(57) ABSTRACT

Segments of a segmented database can store different sets of profile data. Each segment can have a backend that stores profile data, as well as a frontend that stores an index of keys corresponding to the profile data. An auditing system can automatically detect inconsistencies between the frontend and the backend of an individual segment. Based on a key associated with an identified inconsistency, a provisioning system can query a lookup database to determine which segment is associated with the key. The provisioning system can perform operations to automatically resolve the inconsistency within the segment based on whether the lookup database indicates that the segment is or is not associated with the key.

### BACKGROUND

Profile data associated with user accounts, subscriber profiles, or other types of data can be stored in segments of a segmented database. Different profile data, such as profile data for different sets of subscribers, can be stored in different segments of the segmented database. The segments of the segmented database can be distinct and/or isolated. Accordingly, if one segment fails or becomes inaccessible, profile data stored in other segments may remain accessible.

Each segment of the segmented database can have a backend that stores instances of profile data, as well as a frontend that stores an index of keys that correspond to the instances of profile data stored in the backend of the segment. An individual instance of profile data may be associated with multiple keys, such as different keys of varying types. A separate lookup database may maintain mapping data indicating, for each individual key, which segment of the segmented database stores corresponding profile data.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of an auditing system associated with a segmented database.

FIGS. 2A-2D show an example in which, over a period of time, the auditing system can identify and correct an inconsistency between an index in the frontend of a segment of the segmented database and profile data stored in the backend of the segment.

FIG. 3 shows an example system architecture for a computing system that can execute one or more elements of the auditing system.

FIG. 4 shows a flowchart of an example method in which the provisioning system can resolve an inconsistency between an index of keys in the frontend of a segment of the segmented database and profile data stored in the backend of the segment.

### DETAILED DESCRIPTION

A segmented database can be used to store profile data. The profile data may, for example, indicate information associated with user accounts, subscriber profiles, or other types of data associated with subscribers, customers, users, and/or other entities associated with a service provider or other entity.

Instances of profile data, such as profile data associated with individual subscribers, can be associated with corresponding keys. For example, keys may include identifiers of subscribers, identifiers of hardware or other items associated with the subscribers, and/or other types of identifiers. An individual instance of profile data, such as profile data associated with a particular subscriber of a wireless telecommunication network, may be associated with multiple types of keys, such as a Mobile Station International Subscriber Directory Number (MSISDN) associated with the subscriber and an International Mobile Subscriber Identity (IMSI) associated with a Subscriber Identity Module (SIM) used by the subscriber.

The segmented database can be divided into multiple segments, such as different segments that each store different sets of profile data. The different sets of profile data may be associated with different regional areas, different types of subscribers or types of profile data, different ranges of values for a type of key, and/or other differing attributes. As an example, a segmented database associated with an operator of a telecommunication network can configure different segments to store profile data associated with different ranges of IMSI values. Accordingly, profile data associated with a first set of subscribers that use SIMs with IMSI values in a first range may be stored in a first segment of the segmented database, while profile data associated with a second set of subscribers that use SIMs with IMSI values in a second range may be stored in a different second segment of the segmented database.

Each segment can have a backend that stores instances of profile data. Each segment can also have a frontend that stores an index of keys that correspond to the instances of profile data that are stored in the backend of that segment. Accordingly, the index in the frontend of a segment may be used, based on a provided key that is found in the index, to locate and/or access profile data in the backend of the segment that corresponds to the provided key.

A lookup database may maintain mapping data indicating, for each individual key, which segment of the segmented database stores profile data corresponding to the individual key. Accordingly, an element can access profile data in the segmented database by querying the lookup database based on a particular key to identify which segment stores the corresponding profile data.

The mapping data stored at the lookup database can associate the same instance of profile data with multiple corresponding keys, such as keys of different types. Different elements may use the same or different types of keys to access the same profile data.

As an example, if a first instance of profile data is stored in a first segment and is associated with both a MSISDN value and an IMSI value, mapping data at the lookup database can indicate that both the MSISDN value and the IMSI value are associated with the first segment. If a network element is configured to access profile data based on MSISDNs, the network element can use the MSISDN value associated with the first instance of profile data to query the lookup database and determine that the first instance of profile data is stored in the first segment. However, if a different network element is configured to access profile data based on IMSIs, that different network element can use the IMSI value associated with the first instance of profile data to query the lookup database and determine that the first instance of profile data is stored in the first segment. Accordingly, in this example, different network elements can use different types of keys associated with the same instance of profile data to query the lookup database and determine which segment stores the instance of profile data.

The segments of the segmented database can be distinct and/or isolated, such that if one segment fails or becomes inaccessible, profile data stored in other segments may remain accessible. Accordingly, if the segmented database stores profile data associated with subscribers of a telecommunication network, and one segment that holds profile data for one set of subscribers becomes temporarily unavailable, the telecommunication network may still be able to perform authentication operations and/or other operations to connect calls for other sets of subscribers based on profile data stored in other segments that are still available.

Over time, profile data may be added to segments, deleted from segments, moved between segments, edited within segments, and/or otherwise modified. The segments may be configured to update the keys stored in the indexes at the frontends of each segment when corresponding profile data is added, deleted, or otherwise modified, such that the indexes in the frontends of the segments are kept consistent with the profile data stored in the backends of the segments. However, errors, misconfigurations, and/or other issues can cause inconsistencies between frontends and backends of segments to arise over time.

As an example, if profile data associated with a particular key is moved from a backend of a first segment to a backend of a second segment, an error may prevent a corresponding update to an index at a frontend of one of the segments. For instance, an error may cause the index at the frontend of the first segment to erroneously continue to include one or more keys for the profile data that is now no longer present in the backend of the first segment. Similarly, an error may cause the index at the frontend of the second segment to erroneously not be updated to include one or more keys associated with the profile data that was added to the backend of the second segment, such that the backend of the second segment includes profile data that references one or more keys that are not in the index at the frontend of the second segment.

As another example, if the frontend or backend of a segment is restored from a backup, the restoration can lead to an inconsistency between the frontend and the backend of the segment. For instance, if the backend of the segment includes profile data that references a particular key, but the index in the frontend of the segment is restored from an outdated backup that does not include that particular key, the restoration operation can create an inconsistency between the index at the frontend of the segment and the profile data stored in the backend of the segment.

Such inconsistencies can impact operations that use profile data stored in the segmented database. For example, the profile data may be subscriber data associated with subscribers of a telecommunication network as described above. Elements of the telecommunication network may access profile data in the segmented database for various purposes, for instance to perform authentication operations, connect calls, and/or perform other operations based on the profile data. However, if profile data associated with a subscriber is moved from the backend of a first segment to the backend of a second segment, an inconsistency associated with that profile data can arise in the first segment if the index at the frontend of the first segment is erroneously not updated to remove keys associated with the profile data that has been moved to the second segment. Accordingly, if a network element is attempting to connect a call for the subscriber, the network element may attempt to access the profile data from the first segment because the index of the first segment still erroneously indicates that the profile data is stored in the backend of the first segment. Because the profile data had been moved to the second segment, the network element may be unable to access the profile data from the first segment, and setup of the call may fail due to the inconsistency between the index at the frontend of the first segment and the profile data stored in the backend of the segment.

In some segmented database systems, auditing systems may automatically sweep through all of the segments to attempt to identify inconsistencies between frontends and backends of individual segments. Inconsistencies may also be identified in some segmented database systems manually or automatically, for instance in response to errors caused by the inconsistencies. However, identified inconsistencies noted in such segmented database systems are often noted in a log, such the log can later be reviewed manually or automatically to investigate the inconsistencies and/or to determine how to resolve the inconsistencies. However, logging identified inconsistencies for later investigation and resolution can lead to delays in resolving the inconsistencies and prolong periods of time in which the inconsistencies may impact operations that access and/or use profile data in the segmented database.

Additionally, in some segmented database systems, when an inconsistency between a frontend and a backend of a particular segment is identified automatically or manually, operations may be performed within the particular segment that restore or recreate data and thereby resolve the inconsistency between the frontend and the backend of the particular segment. For example, if an error caused an index at the frontend of a segment to omit a key that is referenced within profile data stored in the backend of the segment, the inconsistency may be resolved within the segment by editing the index at the frontend of the segment to restore or add that key. However, such an approach may result in duplicated and/or inaccurate data across different segments.

For example, if an inconsistency between the frontend index and the backend of a first segment arises because profile data was moved from the backend of the first segment to the backend of a different second segment, some systems may attempt to resolve the inconsistency within the first segment by restoring or recreating the profile data in the backend of the first segment, or by restoring or recreating a corresponding key in the frontend index of the first segment. However, because the profile data was moved from the first segment to the different second segment, restoring or recreating data in the first segment can cause the same data to be stored in both the first segment and the second segment. Such duplication of data in different segments can be inefficient, for instance leading to increased memory usage and increased usage of processor cycles and other computing resources to maintain multiple copies of the same data in different segments. Additionally, if data associated with the same key is erroneously stored in different segments, the different copies of the data may be updated inconsistently over time, and/or an erroneous and outdated copy of the data may be inadvertently accessed by other elements.

The systems and methods described herein can automatically audit data stored in individual segments to identify inconsistencies between the frontend indexes of the segments and the backend profile data stored in the segments. If such an inconsistency is identified during an audit of a particular segment, a key associated with the inconsistency can be provided to a provisioning system that has access to multiple segments of the segmented database. The key associated with the inconsistency may be a key that is referenced in the backend profile data but is not in the frontend index, or a key that is in the frontend index but is not referenced in the backend profile data. The provisioning system can use the key, associated with the identified inconsistency, to query the lookup database and determine which segment of the segmented database is associated with the key. Based on identifying which segment is associated with the key in the lookup database, the provisioning system can perform operations to correct the identified inconsistency. For example, if the lookup database indicates that data associated with the inconsistency identified during the audit of the particular segment should be stored in a different segment, the provisioning system can avoid restoring or recreating that data in the particular segment, and instead may cause the particular segment to resolve the inconsistency by deleting data within the particular segment to avoid different copies of data associated with the same key being stored in different segments.

### Example Environment

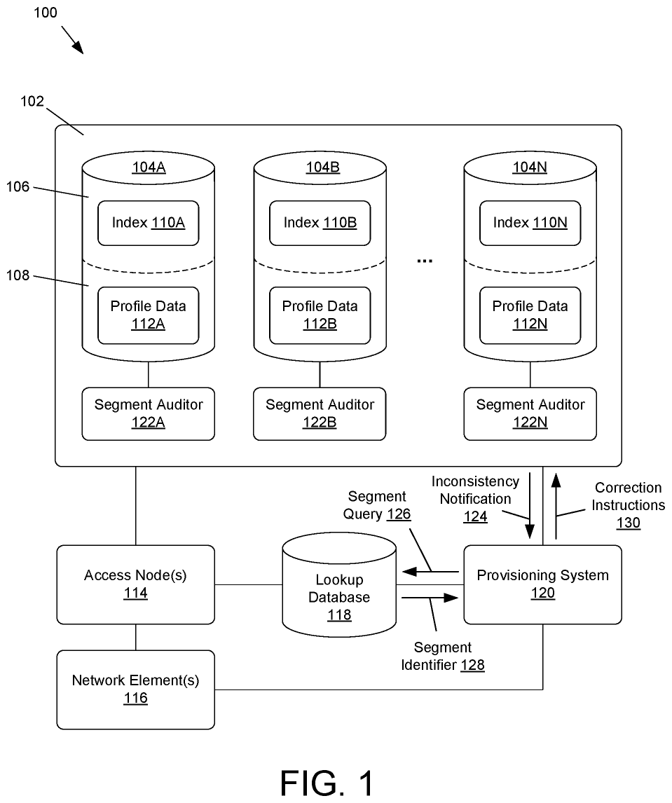

FIG. 1 shows an example of an auditing system 100 associated with a segmented database 102. The segmented database 102 can be divided into multiple segments 104, such as segment 104A, segment 104B, . . . and segment 104N as shown in FIG. 1. Each of the segments 104 can be a distinct database that has a frontend 106 and a backend 108. The frontend 106 of each segment can store an index 110 of keys associated with corresponding profile data 112 that is stored in the backend 108 of each segment.

The profile data 112 can be associated with user accounts, subscriber profiles, billing accounts, and/or other types of information. Individual instances of profile data 112, such as individual user accounts, subscriber profiles, billing accounts, and/or other types of profile data 112, can be associated with one or more keys. In some examples, a particular instance of profile data 112 may be associated with multiple keys, such as different types of keys, as discussed further below. Keys associated with instances of profile data 112 may be indicated within the instances of profile data 112 along with other types of information, and may also be indicated within corresponding indexes of the segments 104. The index 110 in the frontend 106 of a particular segment may accordingly include one or more keys, in some examples including multiple different types of keys, for an individual instance of profile data 112 stored in the backend 108 of the particular segment.

In some examples, the segmented database 102 can be associated with an operator of a telecommunication network, such as a cellular network or other wireless network that provides voice call services, video call services, data services, and/or other services to subscribers. The telecommunication network can be based on one or more radio access technologies, wireless access technologies, protocols, and/or standards, such as fifth generation (5G) New Radio (NR) technology, Long-Term Evolution (LTE)/LTE Advanced technology, other fourth generation (4G) technology, High-Speed Data Packet Access (HSDPA)/Evolved High-Speed Packet Access (HSPA+) technology, Universal Mobile Telecommunications System (UMTS) technology, Code Division Multiple Access (CDMA) technology, Global System for Mobile Communications (GSM) technology, WiMax® technology, WiFi® technology, and/or any other previous or future generation of radio access technology. A subscriber to the telecommunication network can use a user equipment (UE) that is configured to connect to base stations and/or other access points associated with the telecommunication network, such as a mobile phone, a personal digital assistant (PDA), a media player, a tablet computer, a gaming device, a smart watch, a hotspot, an Internet of Things (IoT) device, a personal computer (PC) such as a laptop, desktop, or workstation, or any other type of computing or communication device configured to access the telecommunication network.

In these examples, the profile data 112 can include information about subscribers of the telecommunication network, such as subscriber information, billing information, information about which services the subscribers subscribes to and/or can access, and/or other information associated with the subscribers. Profile data 112 associated with a particular subscriber of the telecommunication network can be associated with one or more types of keys, such as a MSISDN associated with the subscriber, an IMSI and/or Integrated Circuit Card Identification Number (ICCID) associated with a SIM used by the subscriber, public and/or private identifiers associated with the subscriber within an Internet Protocol (IP) Multimedia Subsystem (IMS) and/or other elements of the telecommunication network, such as an IMS Public User Identity (IMPU) and/or IMS Private Identity (IMPI), a customer or subscriber identifier, a billing account identifier, a business account identifier, other account identifiers, a user name, an email address, and/or other types of keys.

Accordingly, profile data 112 associated with a single subscriber of the telecommunication network may be associated with numerous unique keys. Each subscriber of the telecommunication network can be associated with a different set of keys that may include numerous unique keys. As such, there may be thousands, millions, or even billions of different unique keys that may identify corresponding instances of profile data 112 associated with subscribers of the telecommunication network within the segmented database 102.

In other examples, the segmented database 102 can be associated with any other type of entity or service, such as providers of other types of goods or services. In these examples, the profile data 112 can include other types of user accounts, subscriber profiles, billing accounts, and/or other types of profile data 112. The profile data 112 can be associated with one or more types of corresponding keys, such as user names, screen names, profile names, email addresses, phone numbers, other user identifiers, account numbers, and/or other types of keys.

As discussed above, the segmented database 102 can be divided into segments 104. The indexes 110 and corresponding profile data 112 stored in each of the segments 104 can be different. For example, segment 104A can store first profile data 112A and a first index 110A of keys associated with the first profile data 112A, while segment 104B can store second profile data 112B and a second index 110B of keys associated with the second profile data 112B.

In some examples, the segments 104 can be associated with ranges of values associated with a particular type of keys. For instance, in the example discussed above in which profile data 112 may be associated with IMSIs of SIMs used by subscribers of a telecommunication network, segment 104A may be configured to store profile data 112 associated with a first range of IMSI values, while segment 104B may be configured to store profile data 112 associated with a second range of IMSI values. In other examples, different segments 104 can be configured to store profile data 112 associated with different regional areas, different account types, different service levels, different network types, and/or any other differing attribute.

Although the segmented database 102 can segmented into different segments 104 based on a particular type of key or other particular type of attribute, profile data 112 can also be associated with types of keys that are not used to segment the segmented database 102. For instance, in the example discussed above in which different segments 104 are configured to store profile data 112 associated with different ranges of IMSI values, individual instances of profile data 112 may also be associated with other types of keys, such as MSISDNs and/or other keys. Accordingly, although segment 104A may store profile data 112 associated with a particular range of IMSI values, the profile data 112 stored in segment 104A may also be associated with any MSISDN value. The index 110A of segment 104A can accordingly include multiple keys associated with the same instance of profile data 112, such as an IMSI key, a MSISDN key, and/or other keys associated with that instance of profile data 112.

Profile data 112 stored in the segmented database 102 may be accessed by one or more types of access nodes 114. The access nodes 114 can be configured to access profile data 112 from the segments 104 based on types of keys, in some examples in response to requests from other network elements 116.

For example, in a telecommunication network, the access nodes 114 can include a Unified Data Management (UDM) element of a 5G network, a Home Subscriber Server (HSS) of an LTE network, and/or other elements that access subscriber data or other types of profile data 112 stored in the segments 104. In this example, other network elements 116 of the telecommunication network, such as IMS elements, an Access and Mobility Management Function (AMF), a Policy Control Function (PCF), a User Plane Function (UPF), other 5G network functions, similar LTE network elements, and/or other types of network elements 116, can request that a UDM, HSS, or other type of access node 114 retrieve instances of profile data 112. Such network elements 116 may accordingly use profile data 112 retrieved by the access nodes 114 to authenticate subscribers, connect calls, and/or otherwise implement services of the telecommunication network for the subscribers.

Different types of access nodes 114 and/or network elements 116 may be configured to use different types of keys to request and/or identify instances of profile data 112. For example, while some elements may request instances of profile data 112 based on IMSIs, other elements may request the same instances of profile data 112 based on MSISDNs, ICCIDs, IMPIs, IMPUs, and/or other types of keys. Because the segmented database 102 may be segmented based on one type of key or attribute, and not other types of keys or attributes, the access nodes 114 may not natively have information indicating which segment stores profile data 112 associated with a particular key.

However, the segmented database 102 can be associated with a separate lookup database 118 that stores mappings between keys and identifiers of the segments 104 that store profile data 112 associated with those keys. Accordingly, the access nodes 114 can query the lookup database 118 to determine, based on keys identified by the access nodes 114 and/or the network elements 116, which segments 104 store instances of profile data 112 that correspond to those keys. For instance, although in some examples different segments 104 may be associated with different IMSI ranges but can store profile data 112 associated with any MSISDN value, the access nodes 114 can use the lookup database 118 to determine which segments 104 store profile data 112 associated with particular MSISDN values.

The segmented database 102 can also be associated with a provisioning system 120 that can cause data to be added and/or changed within the segments 104 of the segmented database 102. The provisioning system 120 can be an element that can access any or all of the segments 104, for instance to add data within one or more of the segments 104, edit data within one or more of the segments 104, and/or to instruct one or more segments 104 to perform actions as described herein. Accordingly, although the segments 104 may be isolated from one another within the segmented database 102, the provisioning system 120 can perform operations associated with any of the segments 104 and/or multiple segments 104.

The provisioning system 120 can communicate with the lookup database 118 to determine which segments 104 do, or should, store data associated with particular keys. For example, if an account management server, billing server, or other network element 116 indicates that a new subscription is being activated that is associated with a particular MSISDN and IMSI, the network element 116 can provide corresponding profile data 112 associated with the new subscription to the provisioning system 120. If the segments 104 of the segmented database 102 are associated with different IMSI ranges, the provisioning system 120 can query the lookup database 118 to determine which of the segments 104 stores profile data 112 associated with a range of IMSI values that encompasses the particular IMSI that will be associated with the new subscription. Based on an identifier of the segment that is configured to store profile data 112 associated with particular IMSI, provided by the lookup database 118, the provisioning system can add the profile data 112 associated with the new subscription to the backend 108 of the identified segment, and can add the particular MSISDN and IMSI associated with the new subscription to the index 110 stored in the frontend 106 of the identified segment. Based on interactions with the provisioning system 120, the lookup database 118 can also update mapping data to indicate that the identified segment stores profile data 112 associated with the particular MSISDN and IMSI associated with the new subscription.

Although the provisioning system 120 can add new data to segments 104 as described above, the provisioning system 120 can also adjust data stored in the segments 104 and/or take other actions to resolve or respond to inconsistencies that arise between the frontend 106 and backend 108 of individual segments 104. For example, as data in the segments 104 is changed over time, for instance to change profile data 112, change the keys that correspond to the profile data 112, move profile data 112 between segments 104, and/or otherwise change the data or which segment stores the data, the index in the frontend 106 of a segment can become inconsistent with the profile data 112 stored in the backend 108 of that segment. Inconsistencies between the index in the frontend 106 of a segment and the profile data 112 stored in the backend 108 of the segment may also occur due to database transaction collisions in which multiple operations attempt to access the same key and/or profile data simultaneously, due to duplication and/or movement of data when an individual segment is split into multiple segments, and/or for other reasons. However, when such inconsistencies are identified, the provisioning system 120 can automatically correct the inconsistencies as described herein.

Each of the segments 104 can be associated with a segment auditor 122 configured to identify inconsistencies between the index 110 in the frontend 106 of the segment and the profile data 112 stored in the backend 108 of the segment. In some examples, each of the segments 104 can be associated with a different corresponding segment auditor 122, such as segment auditor 122A associated with segment 104A and segment auditor 122B associated with segment 104B shown in FIG. 1.

A segment auditor 122 associated with a segment can be configured to automatically compare the index 110 of keys stored in the frontend 106 of the segment against the profile data 112 stored in the backend 108 of the segment, to determine if any inconsistencies exist between the index 110 in the frontend 106 of the segment and the profile data 112 in the backend 108 of the segment. As an example, the segment auditor 122 associated with a segment can determine that an inconsistency exists if the index 110 stored in the frontend 106 of the segment includes a particular key, but the backend 108 of the segment does not include any profile data 112 that is associated with that particular key. As another example, the segment auditor 122 can determine that an inconsistency exists if the backend 108 of the segment includes profile data 112 that references a key, but that key is not included in the index 110 stored in the frontend 106 of the segment.

In some examples, the segment auditor 122 associated with a segment can be configured to automatically scan the index 110 and the profile data 112 stored in the segment to search for such inconsistencies on a schedule, such as once per hour, once per day, or any other regular or irregular schedule. In other examples, the segment auditor 122 associated with a segment can be configured to automatically scan the index 110 and the profile data 112 stored in the segment to search for such inconsistencies on an on-demand basis in response to an instruction from the provisioning system 120 or another network element, in response to an occurrence of operations that have changed data in the frontend 106 and/or the backend 108 of the segment, and/or in response to any other triggering event.

If the segment auditor 122 associated with a segment identifies an inconsistency between the index 110 and the profile data 112 stored in the segment, the segment auditor 122 can provide a corresponding inconsistency notification 124 to the provisioning system 120. The inconsistency notification 124 may indicate a key that is associated with the identified inconsistency.

As an example, the segment auditor 122 may determine that an instance of profile data 112 stored in the backend 108 of the segment identifies a particular key, but that the particular key is missing from the index 110 in the frontend 106 of the segment. In this example, the inconsistency notification 124 can identify the particular key found in the profile data 112 that is missing from the index 110.

As another example, the segment auditor 122 may determine that the index 110 stored in the frontend 106 of the segment includes a particular key, but that no instances of profile data 112 stored in the backend 108 of the segment are associated with that particular key. In this example, the inconsistency notification 124 can identify the particular key found in the index 110 of the segment that does not correspond with any profile data 112 stored in the backend 108 of the segment.

In response to receiving an inconsistency notification 124 from a segment auditor 122 associated with a segment, the provisioning system 120 can submit a corresponding segment query 126 to the lookup database 118. The segment query 126 can indicate the key associated with the inconsistency identified by the segment auditor 122, based on inclusion of the key in the inconsistency notification 124.

Based on the key that is included in the segment query 126 and is associated with the identified inconsistency, the lookup database 118 can use mapping data stored at the lookup database 118 to determine which of the segments 104 should be storing profile data 112 associated with the key. The lookup database 118 can return a segment identifier 128, identifying the segment that should be storing the profile data 112 associated with the key, to the provisioning system 120 in response to the segment query 126. In some examples, the segment identifier 128 and/or other data returned by the lookup database 118 may also indicate a list of all of the other keys that, based on the mapping data stored by the lookup database 118, are associated with the same profile data 112 associated with the key indicated in the segment query 126.

Based on the segment identifier 128 indicating which segment should be storing profile data 112 associated with the key, the provisioning system 120 can perform one or more corrective actions to resolve or respond to the inconsistency by sending one or more correction instructions 130 to one or more segments 104, and/or the segment auditors 122 associated with those segments 104. In some examples, the correction instructions 130 may cause a segment to delete or edit data within its index 110 and/or profile data 112 to resolve an inconsistency. In other examples, the correction instructions 130 may cause a segment to restore its index 110 and/or profile data 112 from a backup or other data to resolve an inconsistency.

As an example, if segment auditor 122B identifies an inconsistency between index 110B of segment 104B and profile data 112B stored in segment 104B, the segment auditor 122B can identify a key that is associated with the inconsistency within an inconsistency notification 124 sent to the provisioning system 120. The provisioning system 120 can submit a corresponding segment query 126 to the lookup database 118, and receive a segment identifier 128 indicating that segment 104A should be the segment that stores profile data 112 associated with the key, instead of segment 104B. Accordingly, the provisioning system 120 may send correction instructions 130 to segment 104B, and/or the segment auditor 122B associated with segment 104B, that resolves the inconsistency associated with the key within segment 104B. For instance, if the key was indicated within profile data 112B but was missing from the index 110B, the correction instructions 130 may cause the deletion of the profile data 112B that indicated the key within the backend 108 of segment 104B. Similarly, if the key was present in the index 110B but none of the profile data 112B was associated with the key, the correction instructions 130 may cause the key to be deleted from the index 110B of segment 104B. In some examples, the provisioning system 120 may also interact with segment 104A and/or the segment auditor 122A associated with segment 104A to verify that segment 104A actually stores profile data 112 associated with the key, prior to issuing correction instructions 130 that cause deletion of the profile data or the key from segment 104B.

As another example, segment auditor 122B associated with segment 104B may identify an inconsistency within segment 104B, and indicate a corresponding key in an inconsistency notification 124. The provisioning system 120 can include the key in a segment query 126 sent to the lookup database 118. However, in this example, the segment identifier 128 returned by the lookup database 118 may indicate that segment 104B is the correct segment for profile data 112 associated with the key that segment auditor 122B identified as being associated with an inconsistency. Accordingly, the provisioning system 120 can issue correction instructions 130 that cause segment 104B to restore missing information associated with the key to the index 110B or the profile data 112B to resolve the inconsistency. For instance, if the key was present in the profile data 112B but was missing from the index 110B, the profile data 112B and/or a backup of index 110B can be used to restore the key to the current version of the index 110B. If the key was instead present in the index 110B, but profile data 112B corresponding to the key was missing from the backend 108 of segment 104B, a backup of the profile data 112B may be used to restore the profile data 112B corresponding to the key.

In other examples, instead of or in addition to correction instructions 130, the provisioning system 120 can take other actions to respond to an identified inconsistency within a segment. For example, if the inconsistency notification 124 from segment auditor 122B identifies that an inconsistency exists within segment 104B, the provisioning system 120 may trigger a manual audit or further investigation of segment 104B to identify and/or resolve causes of the inconsistency. As another example, if the segment identifier 128 indicates that profile data 112 associated with a particular key associated with an inconsistency within segment 104B should be stored in segment 104A, but profile data 112 associated with that particular key is not stored in segment 104A, the provisioning system 120 may cause segment auditor 122A to perform an audit of segment 104A, cause segment auditors 122 associated with other segments 104 to perform audits to find the profile data 112 associated with the particular key, cause movement of profile data 112 and/or corresponding keys between different segments 104, and/or perform other operations.

As yet another example, the segment identifier 128 and/or other data returned by the lookup database 118 in response to the segment query 126 that identified a key associated with an inconsistency may also indicate a list of all of the other keys that, based on the mapping data stored by the lookup database 118, are associated with the same profile data 112 associated with the key indicated in the segment query 126. Accordingly, based on such a list of other keys associated with an inconsistency, the provisioning system 120 may trigger one or more of the segment auditors 122 to perform audits of corresponding segments 104 in with the other keys, such that the segment auditors 122 may discover any additional inconsistencies associated with those other keys that may exist within the segments 104.

In some examples, each segment may be associated with a different corresponding segment auditor 122 that is configured to audit that segment as discussed above. In other examples, the auditing system 100 can have a segment auditor 122 that is configured to access and audit multiple segments 104. For instance, such a segment auditor 122 may be a component of the provisioning system 120 or other element that is configured to access multiple segments 104 of the segmented database 102. In these examples, the segment auditor 122 can perform separate audits of different individual segments 104 to identify inconsistencies between the indexes 110 and profile data 112 stored by the individual segments 104, and can provide corresponding inconsistency notifications 124 to the provisioning system 120 as described above.

In some examples, individual segment auditors 122 associated with corresponding individual segments 104 can also be configured to access other segments 104. In these examples, the individual segment auditors 122 may be configured to perform some or all of the operations of the provisioning system 120 described herein. For example, if segment auditor 122B identifies an inconsistency within segment 104B, segment auditor 122 may send a segment query 126 to the lookup database 118 directly and receive a segment identifier 128 indicating that corresponding profile data 112 should be stored in segment 104A instead of segment 104B. In this example, the segment auditor 122 may communicate with segment 104A and/or segment auditor 122A to verify that the profile data 112 is stored in segment 104A, and then cause the profile data 112 to be deleted from segment 104B.

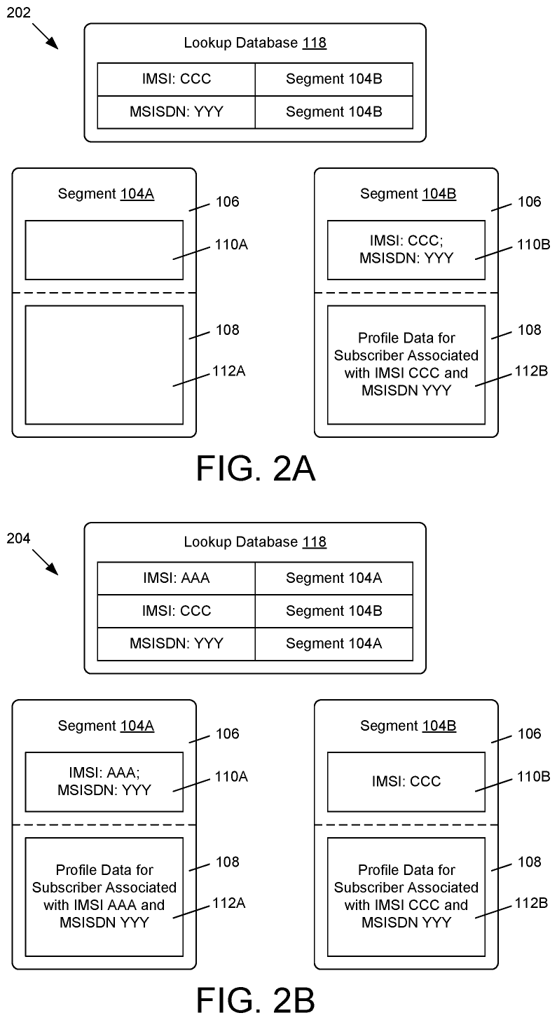

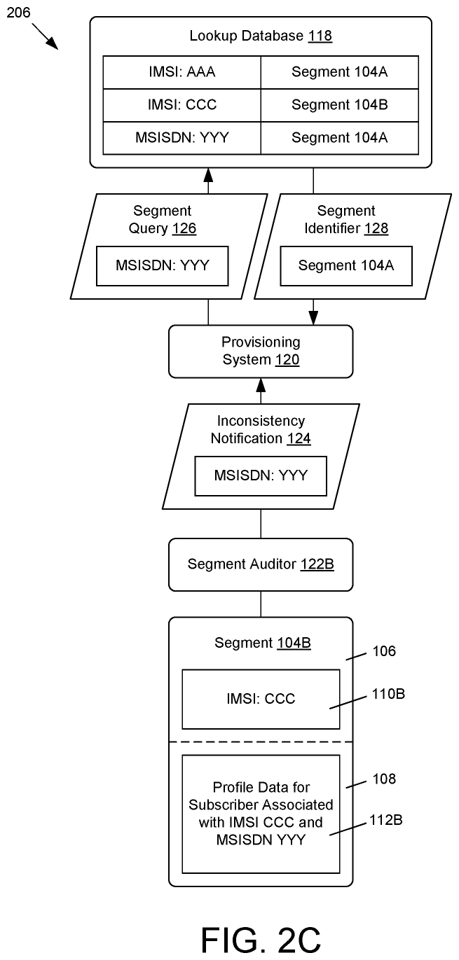

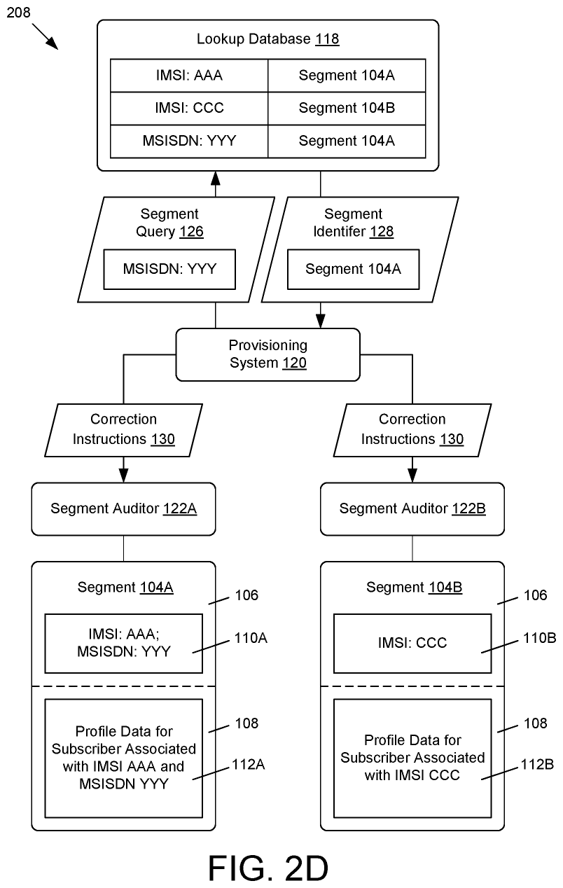

Overall, the auditing system 100 can automatically identify and resolve inconsistencies between indexes of keys stored in frontends of segments and the profile data stored in the backends of the segments. When an inconsistency within a segment is identified the auditing system 100 can determine which of the segments should be storing data associated with the inconsistency, and can adjust data within one or more segments to automatically resolve the inconsistency, avoid duplication of the same data within multiple segments, and/or avoid storage of outdated data in segments. By resolving such inconsistencies within segments automatically, errors that may otherwise occur due to the inconsistencies when elements attempt to access profile data in the segments can be avoided. An example of the auditing system 100 automatically identifying and resolving an inconsistency is discussed further below with respect to FIGS. 2A-2D.

FIGS. 2A-2D show an example in which, over a period of time, the auditing system 100 can identify and correct an inconsistency between an index 110 in the frontend 106 of a segment of the segmented database 102 and profile data 112 stored in the backend 108 of the segment. In the example shown in FIGS. 2A-2D, the segmented database 102 can store profile data 112 associated with subscribers of a telecommunication network. The segmented database 102 can be segmented into segments 104 based on ranges of IMSIs associated with SIMs of the subscribers. For example, segment 104A can be associated with a first range of IMSI values, while segment 104B can be associated with a different second range of IMSI values.

FIG. 2A shows a state 202 at a first time in which the profile data 112B stored in the backend 108 of segment 104B includes profile data for a telecommunication network subscriber who is associated with IMSI CCC and MSISDN YYY. In state 202, the index 110B stored in the frontend 106 of segment 104B includes keys associated with IMSI CCC and MSISDN YYY, thereby indicating that the profile data 112B stored in segment 104B includes profile data for the subscriber associated with IMSI CCC and MSISDN YYY. In state 202, mapping data stored at the lookup database 118 can indicate that profile data associated with both IMSI CCC and MSISDN YYY is stored in segment 104B.

The state 202 shown in FIG. 2A may, in some examples, exist after a network element requested that the provisioning system 120 add profile data for the subscriber associated with IMSI CCC and MSISDN YYY to the segmented database 102. Because the segmented database 102 is segmented based on IMSI values in this example, and IMSI CCC may fall into the second range of IMSI values associated with segment 104B, the provisioning system 120 may have determined from a query of the lookup database 118 that profile data associated with IMSI CCC is to be stored in segment 104B. Accordingly, the provisioning system 120 can have added profile data for the subscriber associated with IMSI CCC and MSISDN YYY to the profile data 112B stored in the backend 108 of segment 104B, and caused corresponding keys for IMSI CCC and MSISDN YYY to be stored in the index 110B in the frontend 106 of segment 104B, as shown in FIG. 2A. Based on the addition of the profile data associated with IMSI CCC and MSISDN YYY to segment 104B, mapping data at the lookup database 118 can also have been updated to indicate that IMSI CCC and MSISDN YYY are associated with segment 104B, as shown in FIG. 2A.

However, at a later point in time, profile data for the subscriber associated with MSISDN YYY may be moved from segment 104B to segment 104A. For instance, a SIM swap operation may be performed to change the subscriber associated with MSISDN YYY from using a SIM associated with IMSI CCC to using a different SIM associated with IMSI AAA. IMSI AAA may be within the first range of IMSI values associated with segment 104A. Accordingly, at state 204 shown in FIG. 2B, the provisioning system 120 and/or other elements may have moved profile data for the subscriber associated with MSISDN YYY, who is now associated with IMSI AAA instead of IMSI CCC, to the backend 108 of segment 104A. As part of the SIM swap operation, the provisioning system 120 and/or other elements may update mapping data at the lookup database 118 to indicate that IMSI AAA and MSISDN YYY are associated with segment 104A, as shown in FIG. 2B.

Data stored at the frontend 106 and/or backend 108 of segment 104B may also be changed as part of the SIM swap operation in response to movement of profile data from segment 104B to segment 104A. However, errors, misconfigurations, and/or other situations may lead to an inconsistency between the data stored at the frontend 106 and the backend 108 of segment 104B. For example, when profile data for the subscriber associated with MSISDN YYY was moved from segment 104B to segment 104A, a key for MSISDN YYY may have been deleted from the index 110B of segment 104B, but profile data in the backend 108 of segment 104B associated with IMSI CCC may have erroneously not been updated to remove a reference to MSISDN YYY, as shown in FIG. 2B. Accordingly, at state 204 shown in FIG. 2B, an inconsistency can exist in segment 104B because the profile data 112B stored in the backend 108 of segment 104B includes a reference to MSISDN YYY, but the index 110B in the frontend 106 of segment 104B does not include MSISDN YYY.

At state 206 shown in FIG. 2C, the segment auditor 122B associated with segment 104B may have performed an audit that compares the index 110B at the frontend 106 of segment 104B with profile data 112 at the backend 108 of segment 104B, and discovered the inconsistency discussed above in which the profile data 112B includes a reference to MSISDN YYY but the index 110B does not include MSISDN YYY. Accordingly, the segment auditor 122B can send an inconsistency notification 124, identifying MSISDN YYY, to the provisioning system 120. In response to the inconsistency notification 124, the provisioning system 120 can send a corresponding segment query 126 to the lookup database 118 that identifies MSISDN YYY. Because mapping data of the lookup database 118 was updated based on the SIM swap operation discussed above to indicate that MSISDN YYY is now associated with segment 104A instead of segment 104B, the lookup database 118 can return a segment identifier 128 indicating that MSISDN YYY is associated with segment 104A as shown in FIG. 2C.

Accordingly, at state 208 shown in FIG. 2D, after the provisioning system 120 sends the segment query 126 indicating MSISDN YYY and receives the corresponding segment identifier 128 indicating segment 104A, the provisioning system 120 can determine that profile data associated with MSISDN YYY should be stored in segment 104A and not in segment 104B. Accordingly, the provisioning system 120 can send correction instructions 130 that cause segment 104B, or the segment auditor 122B, to resolve the inconsistency associated with MSISDN YYY within segment 104B by editing profile data 112B in the backend 108 of segment 104B to remove the reference to MSISDN YYY.

In some examples, the provisioning system 120 may respond to the segment identifier 128 by also send correction instructions 130 to segment 104A and/or segment auditor 122A. The correction instructions 130 can request that segment 104A, or segment auditor 122A, verify that profile data associated with MSISDN YYY is indeed stored in the backend 108 of segment 104A. The provisioning system 120 can accordingly use correction instructions 130 sent to segment 104A and/or segment auditor 122A to verify that segment 104A stores profile data associated with MSISDN YYY before the provisioning system 120 sends correction instructions 130 that cause references to MSISDN YYY to be deleted from segment 104B. By removing the reference to MSISDN YYY from the profile data 112B stored in the backend 108 of segment 104B, the inconsistency associated with MSISDN YYY between the index 110 at the frontend 106 of segment 104B and the profile data 112B in the backend 108 of segment 104B can be resolved.

### Example Architecture

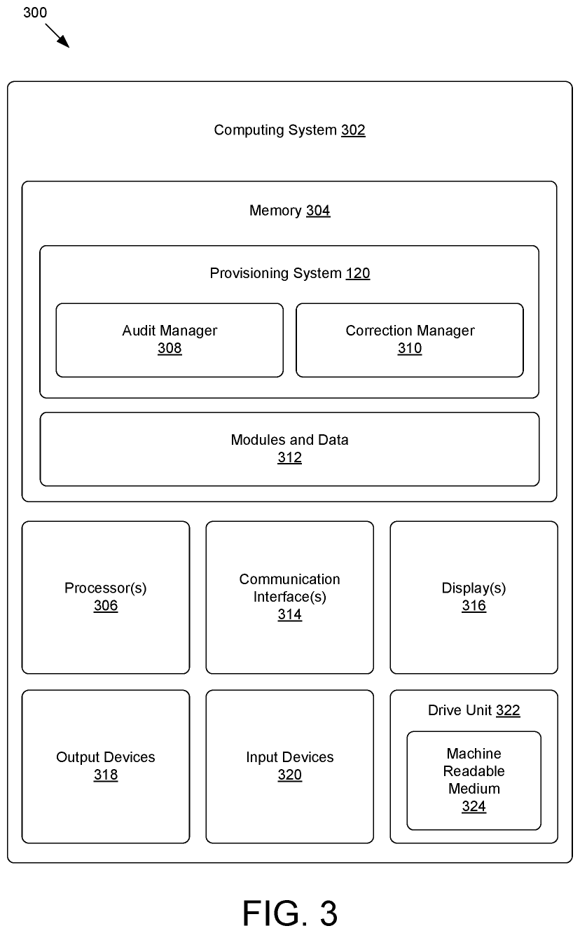

FIG. 3 shows an example system architecture 300 for a computing system 302 that can execute one or more elements of the auditing system 100, such as the provisioning system 120, the lookup database 118, segment auditors 122, and/or other elements described herein. The computing system 302 can include one or more computers, servers, or other types of computing devices. Individual computing devices of the computing system 302 may have the system architecture 300 shown in FIG. 3, or a similar system architecture.

In some examples, elements of the auditing system 100 can be distributed among, and/or be executed by, multiple computing systems or devices similar to the computing system 302 shown in FIG. 3. For instance, in some examples, the provisioning system 120 may execute on a different computing device than segment auditors 122 associated with different segments 104. The computing system 302 may, in some examples, be part of a cloud computing environment or other distributed system that hosts and/or executes one or more elements of the auditing system 100, the segmented database 102, the access nodes 114, the network elements 116, and/or other elements described herein.

The computing system 302 can include memory 304. In various examples, the memory 304 can include system memory, which may be volatile (such as RAM), non-volatile (such as ROM, flash memory, etc.) or some combination of the two. The memory 304 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 302. Any such non-transitory computer-readable media may be part of the computing system 302.

The memory 304 can store one or more software or firmware elements, such as data and/or computer-readable instructions that are executable by one or more processors 306. For example, the memory 304 can store computer-executable instructions and data associated with the provisioning system 120, such as computer-executable instructions and data associated with an audit manager 308 and a correction manager 310. The audit manager 308 may be configured to receive the inconsistency notification 124, send the corresponding segment query 126 to the lookup database 118, and receive the associated segment identifier 128 from the lookup database 118. The correction manager 310 can be configured to determine, based on the inconsistency notification 124 and corresponding segment identifier 128 received from the lookup database 118, how to correct an inconsistency in the segmented database 102, and generate and send associated correction instructions 130 to resolve the inconsistency. The memory 304 can also store other modules and data 312, such as any modules and/or data that can be utilized by the computing system 302 to perform or enable performing any action taken by the computing system 302. Such modules and data 312 can include a platform, operating system, and applications, and data utilized by the platform, operating system, and applications.

The computing system 302 can also have processor(s) 306, communication interfaces 314, a display 316, output devices 318, input devices 320, and/or a drive unit 322 including a machine readable medium 324.

In various examples, the processor(s) 306 can be a central processing unit (CPU), a graphics processing unit (GPU), both a CPU and a GPU, or any other type of processing unit. Each of the one or more processor(s) 306 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 306 may also be responsible for executing computer applications stored in the memory 304, which can be associated with types of volatile (RAM) and/or nonvolatile (ROM) memory.

The communication interfaces 314 can include transceivers, modems, network interfaces, antennas, and/or other components that can transmit and/or receive data over networks or other connections. In some examples, the communication interfaces 314 can be used by the provisioning system 120 to exchange data with segment auditors 122, segments 104, the lookup database 118, other network elements 116, and/or other elements as described herein.

The display 316 can be a liquid crystal display, or any other type of display commonly used in computing devices. For example, a display 316 may be a touch-sensitive display screen, and can then also act as an input device or keypad, such as for providing a soft-key keyboard, navigation buttons, or any other type of input.

The output devices 318 can include any sort of output devices known in the art, such as the display 316, speakers, a vibrating mechanism, and/or a tactile feedback mechanism. Output devices 318 can also include ports for one or more peripheral devices, such as headphones, peripheral speakers, and/or a peripheral display.

The input devices 320 can include any sort of input devices known in the art. For example, input devices 320 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 324 can store one or more sets of instructions, such as software or firmware, that embodies any one or more of the methodologies or functions described herein. The instructions can also reside, completely or at least partially, within the memory 304, processor(s) 306, and/or communication interface(s) 314 during execution thereof by the computing system 302. The memory 304 and the processor(s) 306 also can constitute machine readable media 324.

### Example Operations

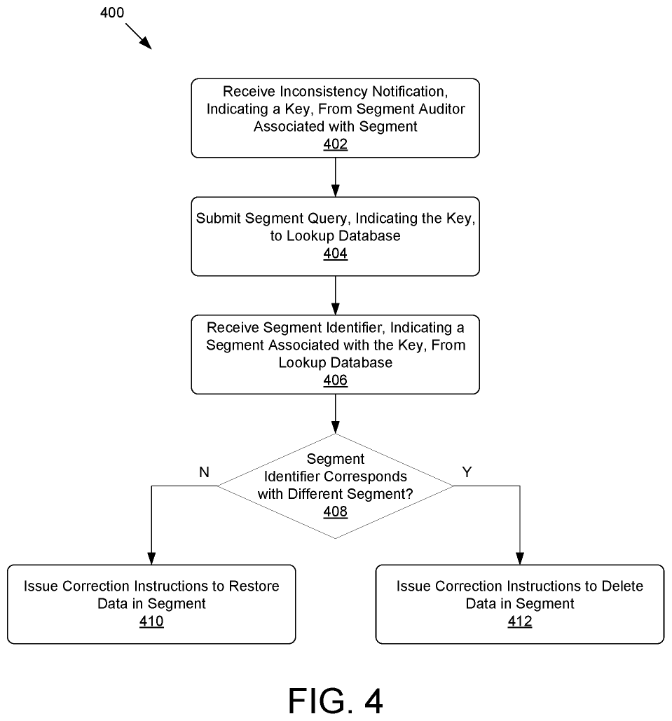

FIG. 4 shows a flowchart of an example method 400 in which the provisioning system 120 can resolve an inconsistency between an index of keys in the frontend 106 of a segment of the segmented database 102 and profile data 112 stored in the backend 108 of the segment. As discussed above, a segment auditor 122 associated with the segment can automatically perform auditing operations to identify inconsistencies between the index 110 of keys stored in the frontend 106 of the segment and profile data 112 stored in the backend 108 of the segment. The provisioning system 120 can use the method 400 to resolve such identified inconsistencies.

At block 402, the provisioning system 120 can receive an inconsistency notification 124 from the segment auditor 122 associated with the segment. The inconsistency notification 124 can be associated with an inconsistency between the index 110 of keys stored in the frontend 106 of the segment and profile data 112 stored in the backend 108 of the segment. In some examples, the inconsistency may be that the index 110 contains a key that is not found within the profile data 112 stored in the backend 108 of the segment. In other examples, the inconsistency may be that the profile data 112 stored in the backend 108 of the segment references a key that is missing from the index 110 stored in the frontend 106 of the segment. The inconsistency notification 124 can identify the key associated with the inconsistency, such as a key that is missing from the index 110 of the segment but is found in the profile data 112 stored by the segment, or a key that is in the index 110 of the segment but is not found in the profile data 112 stored by the segment.

At block 404, the provisioning system 120 can submit a segment query 126, indicating the key provided in the inconsistency notification 124 received at block 402, to the lookup database 118. At block 406, the provisioning system 120 can receive a corresponding segment identifier 128 from the lookup database 118 in response to the segment query 126 sent at block 404. The segment identifier 128 can indicate, based on mapping data maintained at the lookup database 118, which segment of the segmented database 102 corresponds with the key that is associated with the inconsistency and was indicated in the inconsistency notification 124 and the segment query 126. At block 408, the provisioning system 120 can determine whether the segment identifier 128 corresponds with a different segment than the segment in which the inconsistency was identified.

If the segment identifier 128 received at block 406 does not correspond with a different segment (Block 408-No), the segment identifier 128 can indicate that the segment in which the inconsistency was identified is the correct segment that should be storing the data associated with the key indicated by the inconsistency notification 124 and the segment query 126. Accordingly, at block 410 the provisioning system 120 can resolve the inconsistency by issuing correction instructions 130 that cause data associated with the inconsistency to be restored in the segment.

As an example, if the key indicated by the inconsistency notification 124 and the segment query 126 was present in the profile data 112 stored in the backend 108 of the segment, but was not in the index 110 at the frontend 106 of the segment, the correction instructions 130 issued by the provisioning system 120 at block 410 can cause the segment or the corresponding segment auditor 122 to restore the key to the index based on a backup of the index 110 and/or based on the version of the key referenced in the profile data 112 stored in the backend 108 of the segment. As another example, if instead the key indicated by the inconsistency notification 124 and the segment query 126 was present in the index 110 at the frontend 106 of the segment, but profile data 112 corresponding to the key was missing from the backend 108 of the segment, a backup of the profile data 112 may be used to restore the profile data 112 corresponding to the key to the backend 108 of the segment.

If the segment identifier 128 received at block 406 does correspond with a different segment than the segment in which the inconsistency was identified (Block 408—Yes), the provisioning system 120 can resolve the inconsistency at block 412 by issuing correction instructions 130 that cause data associated with the inconsistency to deleted from the segment in which the inconsistency was identified. In some examples, the provisioning system 120 may verify that data associated with the key indicated by the inconsistency notification 124 and the segment query 126 is stored by the segment indicated by the segment identifier 128 received at block 406, before issuing correction instructions 130 at block 412 that causes data to be deleted from the segment in which the inconsistency was identified.

As an example, if the key indicated by the inconsistency notification 124 and the segment query 126 was present in the profile data 112 stored in the backend 108 of the segment, but was not in the index 110 at the frontend 106 of the segment, the correction instructions 130 issued by the provisioning system 120 at block 412 can cause profile data 112 that references, and/or is associated with, the key to be deleted from the backend 108 of the segment. As another example, if instead the key indicated by the inconsistency notification 124 and the segment query 126 was present in the index 110 at the frontend 106 of the segment, but profile data 112 corresponding to the key was not present in the backend 108 of the segment, the correction instructions 130 issued by the provisioning system 120 at block 412 can cause the key to be deleted from the index 110 at the frontend 106 of the segment.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A system comprising:
a segmented database comprising a plurality of segments, each segment of the plurality of segments comprising:
a backend storing profile data; and
a frontend storing an index of keys corresponding to the profile data stored in the backend; and
a lookup database storing mapping data that associates individual keys with identifiers of corresponding segments, of the plurality of segments; and
a provisioning system, associated with the plurality of segments, configured to:
receive an inconsistency notification indicating a key associated with an inconsistency, within a particular segment of the plurality of segments, between:
the index stored in the frontend of the particular segment, and
the profile data stored in the backend of the particular segment;
send, to the lookup database, a segment query indicating the key associated with the inconsistency;
receive, from the lookup database in response to the segment query, a segment identifier that, based on the mapping data, corresponds with the key associated with the inconsistency; and
issuing correction instructions, based at least in part on the segment identifier, that causes a resolution of the inconsistency within the particular segment.

2. The system of claim 1, wherein the inconsistency is based on the key being:
present in the index stored in the frontend of the particular segment, and
omitted from the profile data stored in the backend of the particular segment.

3. The system of claim 1, wherein the inconsistency is based on the key being:
referenced in the profile data stored in the backend of the particular segment, and
omitted from the index stored in the frontend of the particular segment.

4. The system of claim 1, wherein:
the segment identifier indicates that the particular segment, based on the mapping data, corresponds with the key associated with the inconsistency, and
the correction instructions cause the particular segment to restore or recreate information in one of the index or the profile data to resolve the inconsistency.

5. The system of claim 1, wherein:
the segment identifier indicates that, based on the mapping data, a different segment other than the particular segment corresponds with the key associated with the inconsistency, and
the correction instructions cause the particular segment to delete information in one of the index or the profile data to resolve the inconsistency.

6. The system of claim 5, wherein the provisioning system is further configured to:
verify, by communicating with the different segment, that the different segment stores data associated with the key; and
issue the correction instructions, that cause the particular segment to delete the information in one of the index or the profile data, in response to verifying that the different segment stores the data associated with the key.

7. The system of claim 1, further comprising a segment auditor, associated with the particular segment, configured to:
perform an audit of the particular segment to identify the inconsistency within the particular segment; and
send the inconsistency notification, indicating the key associated with the inconsistency, to the provisioning system.

8. The system of claim 7, wherein:
the segment auditor is within a plurality of segment auditors, and
different segment auditors of the plurality of segment auditors correspond to different segments of the plurality of segments.

9. The system of claim 1, wherein:
the profile data is subscriber data associated with subscribers of a telecommunication network, and
the keys include a set of keys associated with a particular instance of the profile data associated with a particular subscriber of the telecommunication network, the set of keys comprising at least one of:
a Mobile Station International Subscriber Directory Number (MSISDN) associated with the particular subscriber,
an International Mobile Subscriber Identity (IMSI) associated with a Subscriber Identity Module (SIM) used by the particular subscriber,
an Integrated Circuit Card Identification Number (ICCID) associated with the SIM,
an Internet Protocol Multimedia Subsystem (IMS) Public User Identify (IMPU) associated with the particular subscriber,
an IMS Private Identity (IMPI) associated with the particular subscriber, or
one or more other identifiers associated with the particular subscriber.

10. The system of claim 1, wherein different segments, of the plurality of segments, are configured to store instances of the profile data that correspond with values of the keys within different ranges of values.

11. A method comprising:
receiving, by a provisioning system associated with a segmented database, an inconsistency notification, wherein:
the segmented database comprises a plurality of segments that each comprise:
a backend storing profile data; and
a frontend storing an index of keys corresponding to the profile data stored in the backend, and
the inconsistency notification indicates a key associated with an inconsistency, within a particular segment of the plurality of segments, between:
the index stored in the frontend of the particular segment, and
the profile data stored in the backend of the particular segment;
sending, by the provisioning system, and to a lookup database associated with the segmented database, a segment query indicating the key associated with the inconsistency;
receiving, by the provisioning system, and from the lookup database, a segment identifier that, based on mapping data stored at the lookup database, corresponds with the key associated with the inconsistency; and
issuing, by the provisioning system, and based at least in part on the segment identifier, correction instructions that causes a resolution of the inconsistency within the particular segment.

12. The method of claim 11, wherein:
the segment identifier indicates that the particular segment, based on the mapping data, corresponds with the key associated with the inconsistency, and
the correction instructions cause the particular segment to restore or recreate information in one of the index or the profile data to resolve the inconsistency.

13. The method of claim 11, wherein:
the segment identifier indicates that, based on the mapping data, a different segment other than the particular segment corresponds with the key associated with the inconsistency, and
the correction instructions cause the particular segment to delete information in one of the index or the profile data to resolve the inconsistency.

14. The method of claim 13, further comprising:
verifying, by the provisioning system, and by communicating with the different segment, that the different segment stores data associated with the key,
wherein the provisioning system issues the correction instructions, that cause the particular segment to delete the information in one of the index or the profile data, in response to verifying that the different segment stores the data associated with the key.

15. The method of claim 11, wherein the inconsistency notification is received from a segment auditor, associated with the particular segment, that is configured to:
perform an audit of the particular segment to identify the inconsistency within the particular segment; and
send the inconsistency notification, indicating the key associated with the inconsistency, to the provisioning system.

16. One or more non-transitory computer-readable media storing computer-executable instructions that, when executed by one or more processors associated with a provisioning system, cause the one or more processors to:
receive an inconsistency notification associated with a particular segment of a segmented database, wherein:
the segmented database comprises a plurality of segments that each comprise:
a backend storing profile data; and
a frontend storing an index of keys corresponding to the profile data stored in the backend, and
the inconsistency notification indicates a key associated with an inconsistency, within the particular segment, between:
the index stored in the frontend of the particular segment, and
the profile data stored in the backend of the particular segment;
send, to a lookup database associated with the segmented database, a segment query indicating the key associated with the inconsistency;
receive, from the lookup database, a segment identifier that, based on mapping data stored at the lookup database, corresponds with the key associated with the inconsistency; and
issue, based at least in part on the segment identifier, correction instructions that causes a resolution of the inconsistency within the particular segment.

17. The one or more non-transitory computer-readable media of claim 16, wherein:
the segment identifier indicates that the particular segment, based on the mapping data, corresponds with the key associated with the inconsistency, and
the correction instructions cause the particular segment to restore or recreate information in one of the index or the profile data to resolve the inconsistency.

18. The one or more non-transitory computer-readable media of claim 16, wherein:
the segment identifier indicates that, based on the mapping data, a different segment other than the particular segment corresponds with the key associated with the inconsistency, and
the correction instructions cause the particular segment to delete information in one of the index or the profile data to resolve the inconsistency.

19. The one or more non-transitory computer-readable media of claim 18, wherein the computer-executable instructions further cause the one or more processors to:
verify, by communicating with the different segment, that the different segment stores data associated with the key; and
issue the correction instructions, that cause the particular segment to delete the information in one of the index or the profile data, in response to verifying that the different segment stores the data associated with the key.

20. The one or more non-transitory computer-readable media of claim 16, wherein the inconsistency notification is received from a segment auditor, associated with the particular segment, that is configured to:
perform an audit of the particular segment to identify the inconsistency within the particular segment; and
send the inconsistency notification, indicating the key associated with the inconsistency, to the one or more processors associated with the provisioning system.
